(19) United States
(12) Patent Application Publication
(10) Pub. No.: US 2013/0267256 A1
(43) Pub. Date: Oct. 10, 2013

(54) REAL-TIME INFORMATION SERVICE

(71) Applicant: NATIONZ TECHNOLOGIES INC., Shenzhen (CN)

(72) Inventor: Yunbo YU, Shenzhen (CN)

(21) Appl. No.: 13/908,729

(22) Filed: Jun. 3, 2013

Related U.S. Application Data
(63) Continuation of application No. PCT/CN2011/078020, filed on Aug. 4, 2011.

(30) Foreign Application Priority Data
Dec. 6, 2010 (CN) 201010574624.6
Dec. 6, 2010 (CN) 201010574636.9

(51) Int. Cl. H04W 4/02

(52) U.S. Cl. CPC H04W 4/02
USPC 455/456.3

(57) ABSTRACT

Systems, devices, and methods allow real time information transmission between a real-time information service system and user terminals in an application space. The system includes an information server; a communication unit; and a positioning unit. The positioning unit and the communication unit are configured to communicate with a user terminal outside the information service system in an application space. The communication unit is configured to further communicate with the information server. The positioning unit is configured to determine a location of the user terminal. The information server is configured to store service information containing location parameters. The information server is configured to provide, via the communication unit, service information to the user terminal that matches the location of the user terminal. As such, the service information and location information can be combined, and location-specific service information can be provided to user terminals at different locations in real time.

### CROSS-REFERENCE TO RELATED APPLICATIONS

The present application is a continuation of PCT/CN2011/078020, filed on Aug. 4, 2011, which claims priority to CN 201010574636.9 and CN 201010574624.6, both filed on Dec. 6, 2010. The disclosures of these applications are hereby incorporated by reference in their entirety.

### BACKGROUND

Mobile terminals can obtain location information via different methods. One utilizes satellite positioning GPS system. Another utilizes mobile base station positioning AGPS system. For example, the existing GPS positioning terminal stores pre-selected maps and other information, and then displays user location information to the user.

### SUMMARY

The present disclosure relates to communications, and particularly relates to a real-time information service system and a method of transmitting real-time information.

In an aspect, an information service system is provided including: an information server; a communication unit; and a positioning unit; wherein the positioning unit and the communication unit are configured to communicate with a user terminal outside the information service system in an application space; wherein the communication unit is configured to further communicate with the information server; wherein the positioning unit is configured to determine a location of the user terminal; wherein the information server is configured to store service information containing location parameters; and wherein the information server is configured to provide, via the communication unit, service information to the user terminal that matches the location of the user terminal.

In some embodiments, the communication unit includes a communication node configured to transmit communication signals, wherein the communication signal are configured to cover the application space.

In some embodiments, the positioning unit includes at least two first positioning nodes, wherein the first position nodes are configured to transmit positioning signals to the user terminal, wherein the positioning signal are configured to cover the application space.

In some embodiments, the positioning signals transmitted by the first positioning nodes contain identification coding information of the first positioning nodes.

In some embodiments, the positioning signals include one or more of a low-frequency electromagnetic signal, an ultrasonic signal, or an infrared signal.

In some embodiments, the positioning unit comprises at least one second positioning node, wherein the second positioning node is configured to store positioning information of the second positioning node, and wherein the positioning information of the second positioning node is configured for capture and storage by the user terminal.

In some embodiments, the positioning information of the second positioning node includes identification coding information of the second positioning node.

In another aspect, a user terminal is provided and configured to interact with an information service system. The information service system includes: an information server; a communication unit; and a positioning unit; wherein the positioning unit and the communication unit are configured to communicate with the user terminal outside the information service system in an application space; wherein the communication unit is configured to further communicate with the information server; wherein the positioning unit is configured to determine a location of the user terminal; wherein the information server is configured to store service information containing location parameters; wherein the information server is configured to provide, via the communication unit, service information to the user terminal that matches the location of the user terminal; and wherein the user terminal includes: a first communication module; and a detection module, wherein the first communication module is configured for short-range communication with the communication unit; and wherein the detection module is configured to receive a positioning signal from the positioning unit, to detect a strength of the positioning signal, and to determine the location of the user terminal.

In some embodiments, the user terminal further includes: a control module; a second communication module; a positioning module; and a memory unit, wherein the control module is configured to control the second communication module to establish communication with the positioning unit, to obtain a initial position information of the user terminal; wherein the positioning module is configured to obtain a distance between the user terminal and the positioning unit; wherein the memory unit is configured to store the initial position information sent by the second communication module; wherein the second communication module is configured for short-range communication with the communication unit.

In some embodiments, the control module is connected with the second communication module, the positioning module, and the memory unit; and wherein the second communication module is further connected with the memory unit.

In some embodiments, the positioning module comprises an acceleration sensor or a displacement sensor.

In another aspect, a method is provided for transmitting real-time information between an information service system and a user terminal, the information service system including: an information server; a communication unit; and a positioning unit; wherein the positioning unit and the communication unit are configured to communicate with the user terminal outside the information service system in an application space; wherein the communication unit is configured to further communicate with the information server; wherein the positioning unit is configured to determine a location of the user terminal; wherein the information server is configured to store service information containing location parameters; wherein the information server is configured to provide, via the communication unit, service information to the user terminal that matches the location of the user terminal; and wherein the method includes: communicating the user terminal with the positioning unit to obtain a initial position information of the user terminal; determining a position of the user terminal based on a distance between the user terminal and the positioning unit; and receiving, at the user terminal, service information provided by the information server, wherein the service information matches the position of the user terminal.

In some embodiments, the user terminal is configured to receive a positioning signal transmitted by the positioning unit and determine the distance between the user terminal and the positioning unit based on a strength of the positioning signal.

In some embodiments, the method further includes: if the user terminal receives the positioning signal transmitted by a positioning node in the positioning unit, then using a position of the positioning node as the initial position, and determining the position of the user terminal based on the strength of the positioning signal transmitted by the positioning node.

In some embodiments, the method further includes: if the user terminal receives positioning signals from two or more positioning nodes in the positioning unit, then determining an intersecting area between the positioning signals transmitted by the two or more positioning nodes; using a position of at least one positioning node as the initial position; and determining the position of the user terminal based on the strength of the positioning signals transmitted by the positioning nodes.

In some embodiments, the method further includes: after the determination of the intersecting area, determining the position of the user terminal by: using the position of any one of the two or more positioning nodes as the initial position; and assessing a distance between the user terminal and the one positioning node by assessing the strength of the positioning signal transmitted by the one positioning node.

In some embodiments, the method further includes: after the determination of the intersecting area, determining the position of the user terminal by: using positions of the at least two positioning nodes as initial positions; respectively assessing strengths of the positioning signal transmitted by each of the at least two positioning nodes to determine a distance between the user terminal and each of at least two positioning nodes, thereby determining the location of the user terminal.

In some embodiments, the user terminal receives service information from the information server by: transmitting, from the user terminal, position information of the user terminal to the information server via the communication unit of the information service system; receiving, at the information server, the position information; selecting, from the service information containing position parameters, service information that matches the position information; transmitting the selected service information from the information server to the user terminal via the communication unit; and receiving, at the user terminal, the service information transmitted by the communication unit.

In some embodiments, the user terminal receives service information from the information server by: transmitting, from the information server via the communication unit of the information service system, service information containing positioning parameters to the user terminals; comparing, at the user terminal, the positioning parameters contained in the received service information with its own position information; and selecting the service information that matches the position information of the user terminal.

In some embodiments, the method further includes: determining locations of a plurality of user terminals; and sending location-specific real time information to the plurality of user terminals based on the determined locations of the plurality of user terminals.

### BRIEF DESCRIPTION OF THE DRAWINGS

FIG. 1 is a diagram illustrating a first approach of implementing the real-time information service system in the present disclosure;

FIG. 2 is a diagram illustrating a second approach of implementing the real-time information service system in the present disclosure;

FIG. 3 is a diagram illustrating the first approach of implementing the user terminal in the present disclosure;

FIG. 4 is a diagram illustrating the first approach of achieving communication between the user terminal with the communication unit and the positioning unit;

FIG. 5 is a diagram illustrating the determination of user terminal location based on the field strength;

FIG. 6 is a diagram illustrating the second approach of implementing the user terminal in the present disclosure;

FIG. 7 is a diagram illustrating an approach of implementing the communication signals;

FIG. 8 is a diagram illustrating the first approach to apply the real-time information service system of the present disclosure to a shopping mall;

FIG. 9 is a diagram illustrating the second approach to apply the real-time information service system of the present disclosure to a shopping mall.

### DETAILED DESCRIPTION

The present disclosure relates to a real-time information service system that can provide real-time service information to user based on user location, a user terminal, and a method of transmitting real-time information.

One aspect of the present disclosure is a real-time information service system configured to provide information to a user terminal in the application space. The system may include an information server, a communication unit and a positioning unit.

The positioning unit and the communication unit both communicate with the user terminals outside the real-time information service system, and the communication unit further communicates with the information server.

The positioning unit is configured to determine the location of the user terminal; wherein the information server stores service information containing location parameters and the information server via the communication unit, provides to the user terminal information that matches the location of the user terminal.

In some embodiments, the communication unit further comprises a communication node for transmitting communication signals, the communication signals covering the application space.

In some embodiments, the positioning unit comprises at least two first positioning nodes. The first position nodes is configured to transmit positioning signals to the user terminal. The positioning signals cover the application space.

In some embodiments, the positioning signals transmitted by the first positioning nodes contain the identification codes of the first positioning node.

The positioning signals may be low-frequency electromagnetic signals, ultrasonic signals, infrared signals or a combination thereof.

In some embodiments, the positioning unit comprises at least one second positioning node, the second positioning node storing the positioning information of the second positioning node, and wherein the user terminal is configured to acquire and store the positioning information of the second positioning node.

The positioning information of the second positioning node may comprise identification codes of the second positioning node.

Another aspect of the present disclosure is to provide a user terminal, comprising: a first communication module and a detection module, wherein the first communication module is used for short-range communication with the communication unit, and wherein the detection module is used for receiving a positioning signal from the positioning unit, for detecting the strength of the positioning signal, and for determining the position information of the user terminal.

The user terminal may further include: a control module, a second communication module, a positioning module, and a memory unit, wherein the control module is connected with the second communication module, the positioning module, and the memory unit; wherein the second communication module is further connected with the memory unit; wherein the control module controls the second communication module to establish communication with the positioning unit, in order to obtain the initial position information of the user terminal; wherein the positioning module is used to obtain the distance between the user terminal and the positioning unit; wherein the memory unit is used for storing the initial position information sent by the second communication module; wherein the second communication module is used for short-range communication between the communication unit.

In some embodiments, the positioning module is an acceleration sensor or a displacement sensor.

In another aspect a method for transmitting real-time information is provided including: communicating a user terminal with a positioning unit to obtain the initial position information of the user terminal; determining the position of the user terminal based on the distance between the user terminal and the positioning unit; and the user terminal receiving from a information server service information that matches the position of the user terminal.

In some embodiment, the user terminal receives the positioning signal transmitted by the positioning unit and determines the distance between the user terminal and the positioning unit based on the strength of the positioning signal.

In some embodiments, the user terminal receives the positioning signal transmitted by a positioning node in the positioning unit, and determines the position of the user terminal based on the strength of the positioning signal transmitted by the positioning node, using the position of the positioning node as the initial position.

In some embodiments, the user terminal receives the positioning signal from two or more positioning nodes in the positioning unit, determines the intersecting area among the positioning signals transmitted by the two or more positioning nodes, and then determines the position of the user terminal based on the strength of the positioning signal transmitted by the positioning nodes, using the position of at least one positioning nodes as the initial position.

In some embodiments, after the determination of the intersecting area the position of the user terminal is determined by assessing the distance between the user terminal and the positioning node via assessing the strength of the positioning signal transmitted by the positioning nodes, using the position of any one positioning node as the initial position.

In some embodiments, after the determination of the intersecting area the position of the user terminal is determined by assessing the distance between the user terminal and each of at least two positioning nodes via assessing the strength of the positioning signals transmitted by each of the at least two positioning nodes, using the position of the at least two positioning nodes as the initial positions.

In some embodiments, the user terminal receives service information from the information server by the following steps: the user terminal transmits the positional information of the user terminal to the information server via the communication unit in the real-time information service system; the information server receives the positioning information, selects the service information containing the position parameters that matches the positioning information, and transmits to the user terminal via the communication unit; and the user terminal receives the service information transmitted by the communication unit.

In some embodiments, the user terminal receives service information from the information server by the following steps: the information server via the communication unit in the real-time information service system transmits service information containing positing parameters to user terminals; the user terminal compares the received service information with its own positioning information and selects the service information that matches the positioning information of the user terminal.

The disclosed technologies may have one or more the benefits such as: combining service information and the location information, so that specific service information can be transmitted real time to user terminals at different locations, based on the location information contained in the user terminals.

Various embodiments are described in detail below with reference to the drawings. Like reference numbers may be used to denote like parts throughout the figures.

Various embodiments disclosed herein help mobile user terminals receive on-the-spot information service, especially in large buildings where many transactions may be made.

Existing positioning systems may not have sufficiently high positioning accuracy. This is particularly true for indoor positioning. As such, existing systems may be incapable of fulfilling the needs of providing indoor location information. In particular, neither of the GPS system nor the system based on base-stations can be applied in large buildings for indoor positioning service.

The GPS method may require the positioning terminal to store a large amount of information. As a result, it may be difficult for the terminal to update on-site or on the spot location information in real time. Additionally, the location service provided by the existing positioning system is not organically combined with a communication system. That is, the location service cannot provide to user terminal service information that matches the location information provided by the positioning system.

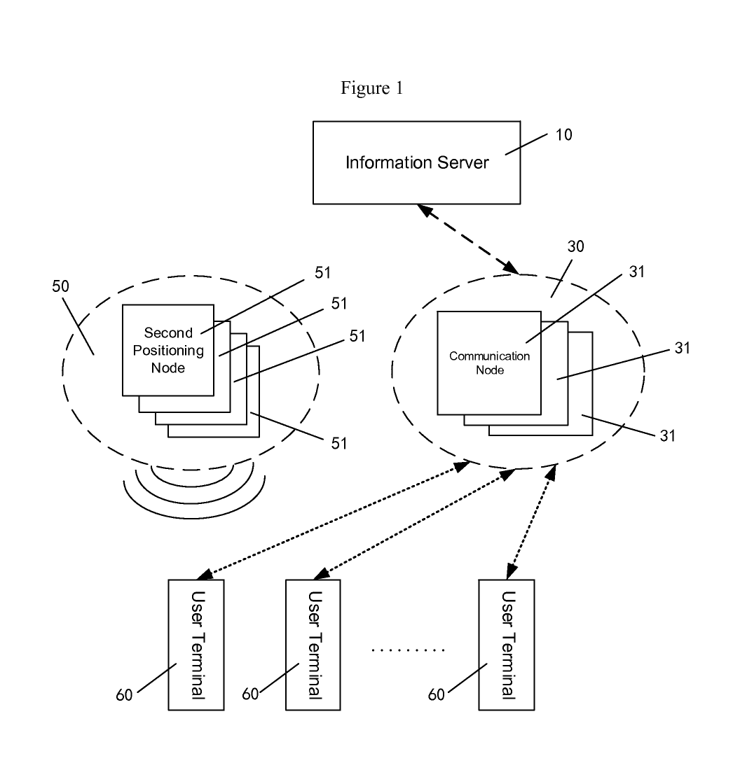

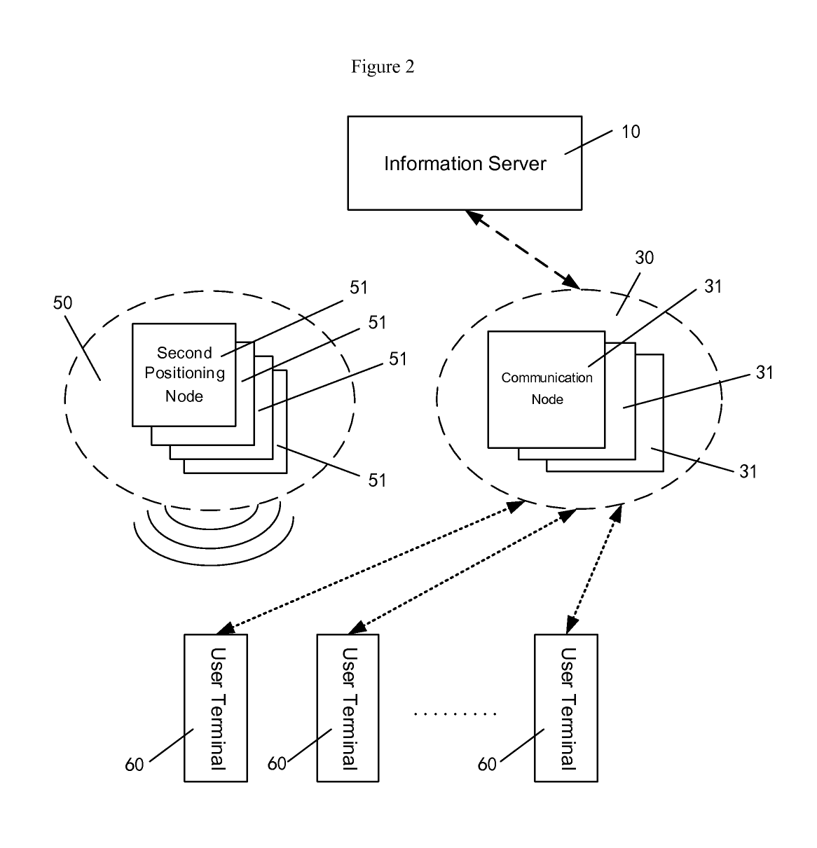

The first aspect of the present disclosure is a real-time information service system, which is used to provide information to a user terminal in an indoor application space or an outdoor application space, see FIGS. 1 and 2. The system comprises the information server 10, the communication unit 30, and the positioning unit 20 (or 50). The positioning units 20 (or 50) and the communication unit 30 both communicate with a user terminal 40 (or 60) outside the real-time information service system. Communication unit 30 also communicates with the information server 10. Positioning units 20 and 50 are used to determine the position of the user terminals. Service information including product location parameters is stored in the information server 10. That is, the information server 10 harbors service information and the location parameters corresponding to the service information. Information server 10 via the communication unit 30 provides to the user terminal services information that matches the location of the user terminal.

As shown in FIGS. 1 and 2, communication unit 30 further contains at least one communication node for transmitting a communication signal. The at least one communication node is laid out according to the shape of the application space and forms communication unit 30, thus enabling the communication signal from communication unit 30 to cover the application space.

The positioning unit in the real-time information service system of the present disclosure can be implemented in at least the following two approaches.

The first approach to implement the positioning unit according to some embodiments disclosed herein, shown in FIG. 1 as positioning unit 20, comprises at least two first positioning nodes 21, which transmit a positioning signal to user terminal 40. Positioning unit 20 is formed by laying out at least two first positioning nodes 21 according to the shape of the application space, so that the positioning signal from positioning unit 20 covers the application space. Further, the positioning signal transmitted to user terminal 40 by the first positioning nodes 21 contains the identification code information of the first positioning nodes.

The second approach to implement the positioning unit according to some embodiments of the present disclosure, shown in FIG. 2 as positioning unit 50, comprises at least one second positioning node 51, which stores node position information of the second positioning node. The at least one second positioning node 51 is deployed in the application space. User terminal 60 acquires and saves the position information of the node of the second positioning, and determines the position of user terminal 60 based on the distance between the second positioning node and user terminal 60. Also contained in the node position information is the identification code information of the second positioning node.

Depending on how the positioning unit is implemented, there may be two or more ways to implement the real-time information service system of the present disclosure.

When adopting the positioning unit implemented in the first approach described above, the real-time information service system may be implemented as described below.

First, positioning unit 20 can be set up in the actual application site. Positioning unit 20 comprises at least two first positioning nodes 21, each of which is laid in a pre-set physical location according to their own coding, and each of which constantly transmits positioning signal from the site. More specific implementation steps are as follows:

1) Predetermine the scope of the application site that needs to be covered by the positioning signal according to the shape of the application space;

2) According to the coverage scope of each first positioning node 21's positioning signal, divide the application site into a number of positioning cells, encode the positioning cells, so that each positioning cell has an identification code;

3) Set up an on-site first positioning node 21 at the center of each positioning cell. Store the identity coding information in first position node 21 placed inside the positioning cell. While transmitting positioning signals to user terminal 40, first position node 21 also transmits the identity coding information to user terminal 40, so that it is easy for the user terminal to determine an initial position.

Within the application space, the more first positioning nodes are laid out, the lower power user terminal 40 would consume in receiving positioning signals, and the more accurate the positioning would be. Positioning signals could be low-frequency electromagnetic signals, ultrasonic signals, infrared signals, or any combination thereof.

Communication unit 30 can then be set up in the application site. Communication unit 30 comprises at least one field communication node 31. In accordance with their encodings, each communication node 31 is laid out in a pre-set physical location, and exchanges data with information server 10 and user terminal 40 located in the application site. The specific implementation steps are as follows:

1) According to the shape of the application site, predetermine the scope of the application site that needs to be covered by the communication signal. The scope is at least as large as the predetermined scope of the positioning signals' coverage discussed above.

2) According to the coverage range of the communication signal from one communication node 31, divide the application site into a number of communication cells, and then encode each communication cell so that each communication cell has an identification code;

3) Set up a communication node 31 at the center of each communication cell, and then store the identification code information of the communication cell in communication node 31.

Each communication node 31 is capable of transmitting and receiving RF signals, and communicates bidirectionally with information server 10 and user terminal 40. RF signal can follow Wi-Fi, Bluetooth or other communication protocol.

Information server 10 can be initialized. For example, store the following in information server 10: identification codes of each first positioning node, identification codes for each communication node, the layout position and signal coverage of each first positioning node. The first approach of constructing a real-time information service system of the present disclosure can thus be completed.

The positioning signals from first positioning node 21 and communication signals from communication node 31 may occupy the same or different frequency bands. In general, the lower the frequency of the positioning signals relative to the frequency of the communication signals, the better resistance the positioning signals will have against environmental interference.

When adopting the positioning unit implemented in the second approach, the real-time information service system is implemented as described below.

First, positioning unit 50 is established at the application site. Positioning unit 50 comprises at least one second positioning node 51, within each having the node position information stored therein. Second positioning node 51 can be set up at any location within the application site. User terminal 60 can establish communication with any one of the second positioning nodes at the application site for position calibration. During the calibration, user terminal 60 is placed adjacent second positioning node 51, maintained stationary to establish communication with second positioning node 51, and obtain the node position information of second positioning node 51, with the node position information serving as an initial position of user terminal 60. The node position information acquired by user terminal 60 also contains the identification code of the second positioning node.

Next, set up communication unit 30 in the application site. Communication unit 30 comprises at least one field communication node 31. In accordance with their encodings, each communication node 31 is laid in a pre-set physical location, and exchanges data with information server 10 and user terminal 60 located in the application site. The specific implementations may include:

1) According to the shape of the application site predetermine the scope of the application site that needs to be covered by the communication signal.

2) According to the coverage range of the communication signal from one communication node 31, divide the application site into a number of communication cells, and then encode each communication cell so that each communication cell has an identification code;

3) Set up a communication node 31 at the center of each communication cell, and then store the identification code information of the communication cell in communication node 31.

Each communication node 31 is capable of transmitting and receiving RF signals, and communicates bidirectionally with information server 10 and user terminal 40. RF signal can follow Wi-Fi, Bluetooth or other communication protocol.

Finally, initialize information server 10. That is, store the following in information server 10: identification codes of each communication node, the layout position and signal coverage of each communication node, identification codes and layout position of each second positioning node.

As a second aspect of the present disclosure, also provided is the implementation of a user terminal.

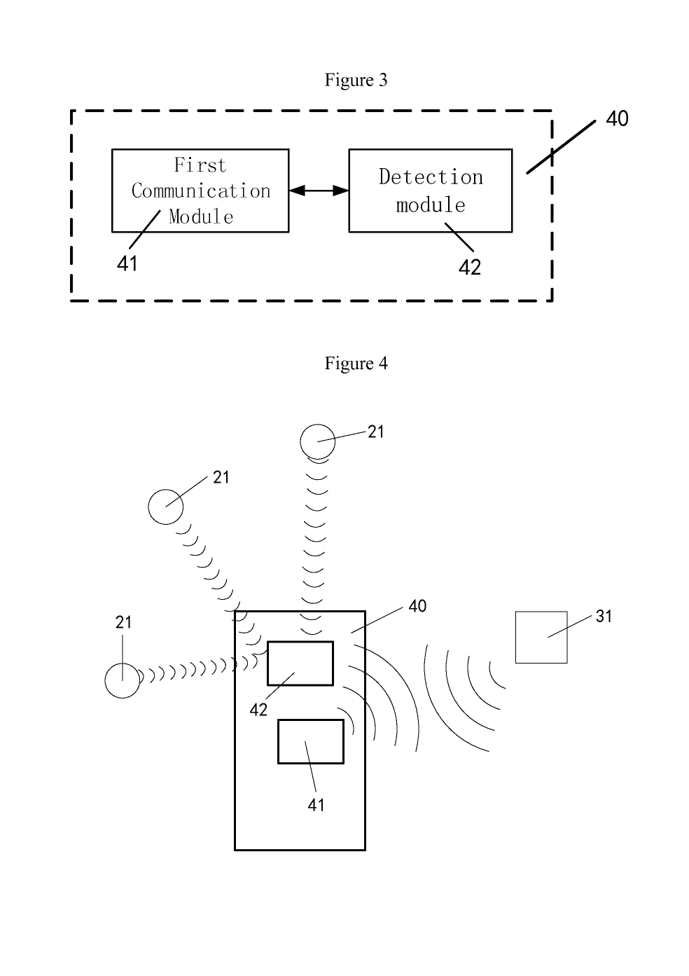

As the first way to implement the user terminal, as shown in FIG. 3, user terminal 40 includes a first communication module 41 and detection module 42. Detection module 42 receives positioning signal from positioning unit 20 and assesses the strength of the positioning signal, and then determines the location of user terminal 40; first communication module 41 is used to achieve short-range communication with communication unit 30. The communication includes two aspects: First, it transmits user terminal 40's position information from detection module 42 to communication unit 30. Second, it receives service information transmitted by information server 10 via communication unit 30. When moving in the application site, user terminal 40 may need to maintain communication with first positioning node 21 and communication node 31. As a result it is more suitable for user terminal 40 to adopt short-range communication technology in the present disclosure.

As shown in FIG. 4, first communication module 41 may receive and extract service information provided by communication node 31 within communication unit 30. First communication module 41 adopting short-range communication function to communicate with communication node 31 greatly reduces the power consumption of user terminal 40, thereby resulting in great practical significance. The UHF band RF SIM card technology (disclosed in Patent No. ZL200710124354.7) can also be applied to the present disclosure. The UHF band RF SIM card can be implanted in user terminal 40, so that user terminal 40 is capable of receiving and transmitting short-range RF signal.

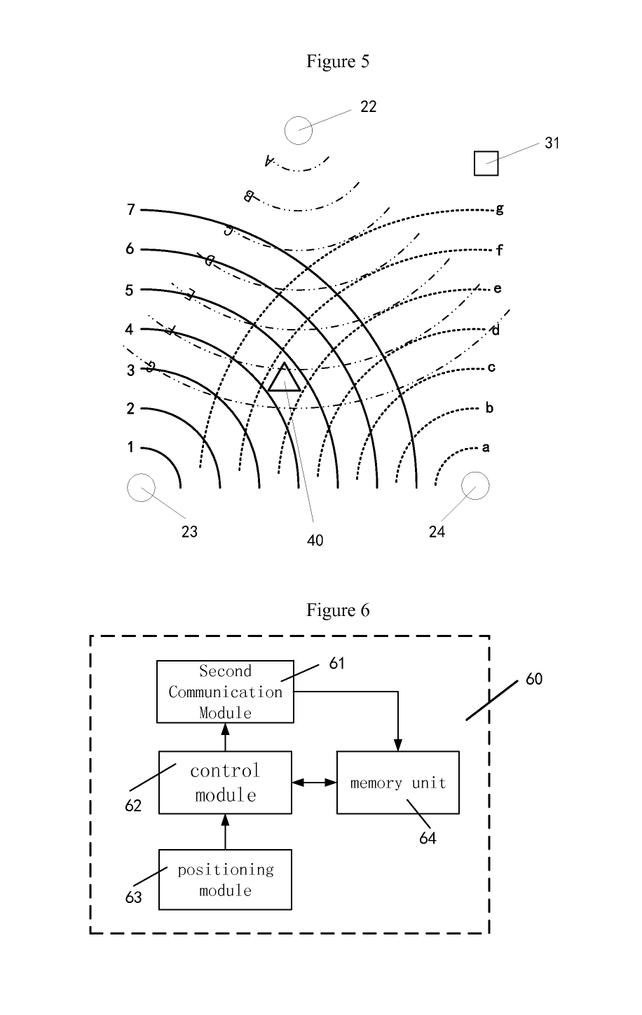

As shown in FIG. 4, detection module 42 can simultaneously receive a plurality of positioning signals transmitted by the first positioning node, as well as assess the strength of the positioning signals. As shown in FIG. 5, positioning unit 20 contains three first positioning nodes 22, 23 and 24, each of which transmits fixed-power RF signal according to each node's preset frequencies, with the RF signal containing each first positioning node's identification code information. User terminal 40 contains a field strength RSSI receiving apparatus (i.e., detection module 42), and is capable of simultaneously receiving the transmitted RF signals from the three first positioning nodes described above, as well as assessing the field strength of the RF signals. User terminal 40 then measures the range of distances between itself and first positioning nodes 22, 23 and 24 by measuring the field strength of the RF signals. RSSI (Received Signal Strength Indication) is a positioning technology that measures the distance between the signal point and the receiving point via assessing the strength of the received signal, and in turn calculates positions based on the corresponding data. As shown in FIG. 5, user terminal 40 sits between micro-zones f and e of first positioning node 24, recorded as “f”; user terminal 40 also sits between micro-zones 5 and 4 of first positioning node 23, recorded as “5”; user terminal 40 further sits between micro-zones G and F of first positioning node 22, recorded as “G”. Therefore the positioning micro-zone where user terminal 40 sits is coded as “f5G”. While performing the calculations above, user terminal 40 demodulates the identification code information of the three first positioning nodes from the received positioning signals. User terminal 40 can perform calculation using as a initial point the position of any one of the three nodes 22, 23 and 24, thereby obtaining its own positioning information. Alternatively, user terminal 40 can take as initial position the positions of all three nodes 22, 23, 24, calculate the distances between itself and each node, and then determine the position information of user terminal 40 based on the consideration of all three distances.

In the second way to implement the user terminal, as shown in FIG. 6, user terminal 60 contains control module 62, second communication module 61, positioning module 63 and memory unit 64. Control module 62 is connected to second communication module 61, positioning module 63, and memory unit 64. Second communication module 61 is also connected to the memory 64. Control module 62 controls the establishment of communication between second communication module 61 and positioning unit 50, thereby obtains initial position information of user terminal 60. Positioning module 63 is used to obtain the distance between user terminal 60 and positioning unit 50. Memory unit 64 is used for storing the start position information sent by second communication module 61. Second communication module 61 is used for implementing short-range communication with communication unit 30. Furthermore, positioning module 63 can be an acceleration sensor or a displacement sensor.

A third aspect of the present disclosure is a method of transmitting real-time information. Communications nodes are laid out in the application space and form a communication unit. Positioning nodes are laid out in the application space and forms a positioning unit. The real-time information service system can transmit service information as follows:

First, the user terminal communicates with the positioning unit to obtain the initial position of the user terminal.

Second, determine the real-time location of the user terminal according to the distance between the user terminal and the positioning unit.

Third, the user terminal receives service information that matches the position of the user terminal from information server 10 in the real-time information service system.

If the real-time information service system utilizes the first way of implementing the positioning unit, user terminal 40 receives signal from positioning unit 20, and then determines the distance between user terminal 40 and positioning unit 20 based on the signal's strength.

If the positioning signal from one first positioning node is received, user terminal 40 takes as initial position the position of the first positioning node and then determines the micro-zone in which user terminal 40 resides, based on the strength of the signal transmitted from the first positioning node, thereby determining the position of user terminal 40.

If positioning signals from two or more first positioning nodes are received, user terminal 40 determines the intersecting area of the signals transmitted by the two or more first positioning nodes, takes as initial position the location of at least one first positioning node, and then determines the position of user terminal 40 based on the strength of the positioning signal transmitted by the first positioning node. For example, user terminal 40 first determines the specific micro-zones of the different positioning nodes based on the strengths of different positioning signal, and then takes the intersecting area of each micro-zone as the positioning micro-zone of user terminal 40. User terminal 40 then determines its current position by taking the position of any one positioning node as the initial position.

Relying on signal strength to determine the position of user terminal 40 reduced the number of positioning nodes needed to be laid out in the application field, thereby greatly reduced the complexity and cost of laying out the service system, resulting in more practical utility of the service system in the present disclosure.

Furthermore, if receiving the positioning signal from two or more first positioning nodes, after determining the intersecting area described above, the position of user terminal 40 can be determined as follows: take as initial position the location of any one first positioning node, and then determines the position of user terminal 40 based on the strength of the positioning signal transmitted by the first positioning node. To improve the accuracy of the determination of user terminal 40's position, one can take positions of at least two first positioning nodes as initial positions, assess the signal strength of each first position node, determine the distance between user terminal 40 and each first positioning node, and then consolidate the multiple distances to determine user terminal 40's position.

If the real-time information service system utilizes the second way of implementing the positioning unit, user terminal 60 establishes communication with one second positioning node in positioning unit 50. Because each of the second positioning nodes contains its respective node position information, user terminal 60 can obtain the position(s) of the second positioning node(s) as the initial position(s) of user terminal 60. Subsequently, user terminal 60's position can be determined via the calculation of movement by positioning module 63 and the distance between user terminal 60 and the second positioning node(s) with which user terminal 60 established communication.

Furthermore, in the third step of the above described method of transmitting real-time information, user terminal 40 or 60 can receive service information matching its position from information server 10 via the following two approaches.

In the first approach, user terminal 40 or 60 first obtains its own position information and transmits the position information to information server 10 via communication unit 30. Next, information server 10 receives the position information described above, compares it with the positional parameters stored on server 10, selects positional parameters matching the position information from user terminal 40 or 60, and then transmits service information corresponding to the selected positional parameters (i.e., product information at the corresponding position) to user terminal 40 or 60 via communication unit 30. Finally, user terminal 40 or 60 receives and displays to user the matching service information from information server 10.

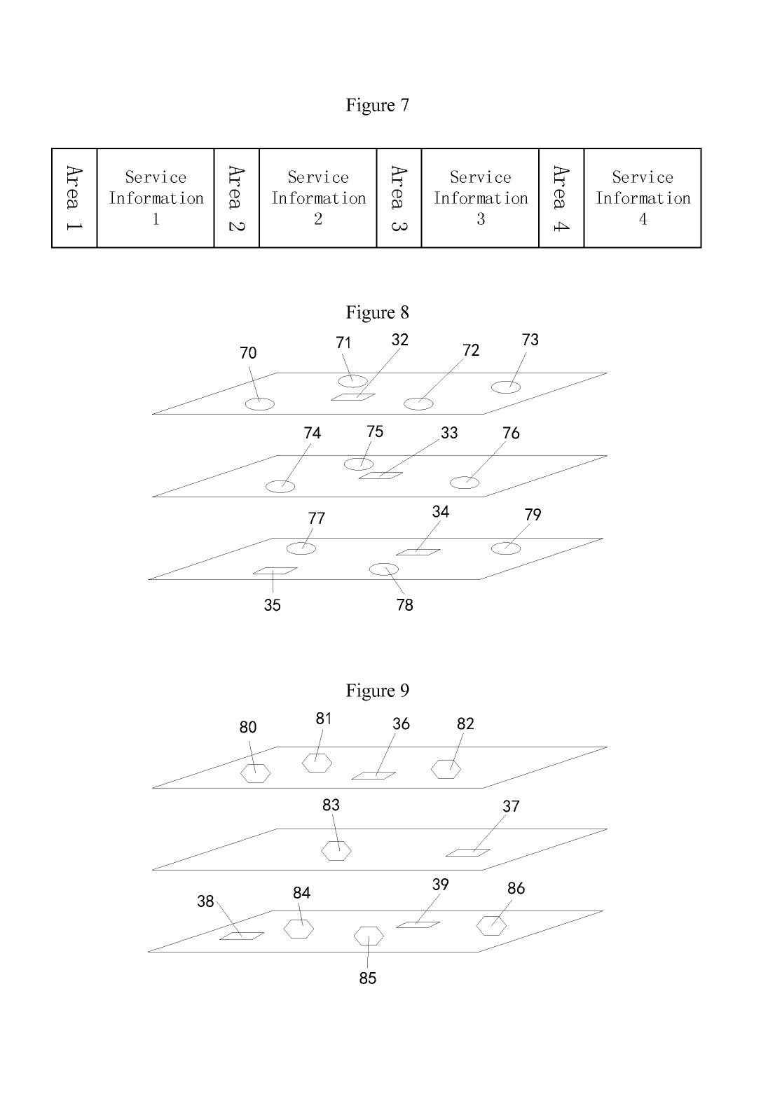

In the second approach, information server 10 continuously transmits positional-parameter-containing service information to user terminal 40 or 60 via communication unit 30. Next, after receiving the service information, user terminal 40 or 60 compares its own position information with the positional parameters in the service information, selects from a plurality of service information the service information that contains the matching positional parameters. FIG. 7 shows a schematic diagram of the communication signal from communication node 31 sent during the above information transmitting process. User terminal 40 or 60 extracts, processes and displays the matching service information based on its own positional information.

Below is a brief introduction to the application of real-time information service system disclosed in the present disclosure.

FIG. 8 is a schematic diagram showing the first kind of layout applying the real-time information service system disclosed herein in a shopping mall. First positioning nodes 70 to 79 are laid out on first to third floor of the mall, with their positioning signal covering different areas of each floor. Communication nodes 32 to 35 are also laid out on first to third floor of the mall, with their communication signal covering different areas of each floor. Stored in information server 10 are the physical locations where the communication nodes and the first positioning nodes are laid out, the identification codes of the physical locations, the service information that matches the physical locations (i.e., information of products at the physical locations). Information server 10 transmits service information to each communication node, and then, via the communication nodes, to user terminal 40. That is, information server 10 transmits to communication node 32 product information that matches first positioning nodes 70, 71, 72 and 73, which are on the third floor of the mall. Consequently, user terminal 40, when at different first positioning node locations, receives and displays real-time product information of the corresponding physical location. This way, upon determining a customer's location, product information and description of the counters and shelves corresponding to that location can then be transmitted to the moving user terminal 40 by the mall based on its product layout. Additionally, when choosing a product, a customer can also reference other customers' review of the products at the counters and shelves. Furthermore, when products are moved to different locations on the same floor or to different floors, the information service system disclosed herein is flexible such that reinitializing information server 10 can update the stored information.

FIG. 9 is a schematic diagram showing the second kind of layout applying the real-time information service system disclosed herein in a shopping mall. Second positioning nodes 80 to 86 are laid out on first to third floor of the mall, with their positioning signal covering different areas of each floor. Communication nodes 36 to 39 are also laid out on first to third floor of the mall, with their communication signal covering different areas of each floor. Stored in information server 10 are the physical locations where the communication nodes and the second positioning nodes, the identification codes of the physical locations, the service information that matches the physical locations (i.e., information of products at the physical locations). Information server 10 transmits service information to each communication node, and then, via the communication nodes, to user terminal 60. When the user enters the third floor, user terminal 60 first establishes communication with any one of second positioning nodes 80, 81 and 82. For example, user terminal 60 can first establish communication with second positioning node 80 for position calibration. That is, when user terminal 60 remains relatively stationary near second positioning node 80, position information of second communication node 80 is obtained via communication between second communication module 61 and second positioning node 80. The position information serves as the initial position of user terminal 60 and is stored in internal memory unit 64. When user terminal 60 moves, positioning module 63 contained therein can detect the movement, obtain the movement information and send it to control module 62 for processing. Positioning module 63 comprises an acceleration sensor, e.g., the electron gyroscope. Positioning module 63 measures user terminal 60's acceleration and send it to control module 62. Control module 62 calculates user terminal 60's displacement relative to its original location according to the formula s=v₀t+at²/2 (wherein s is the displacement; v₀ is the initial velocity, which is zero due to calibration when user terminal 60 is stationary; “a” is the detected acceleration; t is the time passed since calibration). That is, control module 62 calculates the distance between user terminal 60 and second positioning node 80 to determine the latest position of the moving user terminal 60. Information server 10 then transmits via communication node 36 service information matching user's current location to user terminal 60 for display. This way, when user is shopping at the mall, upon determining a user's location, product information and description of the counters and shelves corresponding to that location can then be transmitted to the moving user terminal 60 by the mall based on its product layout. Additionally, similar to the first kind of layout applying the real-time information service system, when choosing a product a customer can also reference other customers' review of the products at the counters and shelves. Furthermore, when products are moved to different locations on the same floor or to different floors, the information service system disclosed herein is flexible such that reinitializing information server 10 can update its stored information.

All references cited in the description are hereby incorporated by reference in their entirety. While the disclosure has been described with respect to a limited number of embodiments, those skilled in the art, having benefit of this disclosure, will appreciate that other embodiments can be advised and achieved which do not depart from the scope of the description as disclosed herein.

1. An information service system comprising:
an information server;
a communication unit; and
a positioning unit;
wherein the positioning unit and the communication unit are configured to communicate with a user terminal outside the information service system in an application space;
wherein the communication unit is configured to further communicate with the information server;
wherein the positioning unit is configured to determine a location of the user terminal;
wherein the information server is configured to store service information containing location parameters; and
wherein the information server is configured to provide, via the communication unit, service information to the user terminal that matches the location of the user terminal.

2. The system of claim 1, wherein the communication unit comprises a communication node configured to transmit communication signals, wherein the communication signal are configured to cover the application space.

3. The system of claim 1, wherein the positioning unit comprises at least two first positioning nodes, wherein the first position nodes are configured to transmit positioning signals to the user terminal, wherein the positioning signal are configured to cover the application space.

4. The system of claim 3, wherein the positioning signals transmitted by the first positioning nodes contain identification coding information of the first positioning nodes.

5. The system of claim 4, wherein the positioning signals comprise one or more of a low-frequency electromagnetic signal, an ultrasonic signal, or an infrared signal.

6. The system of claim 1, wherein the positioning unit comprises at least one second positioning node, wherein the second positioning node is configured to store positioning information of the second positioning node, and wherein the positioning information of the second positioning node is configured for capture and storage by the user terminal.

7. The system of claim 6, wherein the positioning information of the second positioning node comprises identification coding information of the second positioning node.

8. A user terminal configured to interact with an information service system,
the information service system comprising:
an information server;
a communication unit; and
a positioning unit;
wherein the positioning unit and the communication unit are configured to communicate with the user terminal outside the information service system in an application space;
wherein the communication unit is configured to further communicate with the information server;
wherein the positioning unit is configured to determine a location of the user terminal;
wherein the information server is configured to store service information containing location parameters;
wherein the information server is configured to provide, via the communication unit, service information to the user terminal that matches the location of the user terminal; and
wherein the user terminal comprises:
a first communication module; and
a detection module,
wherein the first communication module is configured for short-range communication with the communication unit; and
wherein the detection module is configured to receive a positioning signal from the positioning unit, to detect a strength of the positioning signal, and to determine the location of the user terminal.

9. The user terminal of claim 8, further comprising:
a control module;
a second communication module;
a positioning module; and
a memory unit,
wherein the control module is configured to control the second communication module to establish communication with the positioning unit, to obtain a initial position information of the user terminal;
wherein the positioning module is configured to obtain a distance between the user terminal and the positioning unit;
wherein the memory unit is configured to store the initial position information sent by the second communication module;
wherein the second communication module is configured for short-range communication with the communication unit.

10. The user terminal of claim 9, wherein the control module is connected with the second communication module, the positioning module, and the memory unit; and wherein the second communication module is further connected with the memory unit.

11. The user terminal of claim 9, wherein the positioning module comprises an acceleration sensor or a displacement sensor.

12. A method for transmitting real-time information between an information service system and a user terminal,
the information service system comprising:
an information server;
a communication unit; and
a positioning unit;
wherein the positioning unit and the communication unit are configured to communicate with the user terminal outside the information service system in an application space;
wherein the communication unit is configured to further communicate with the information server;
wherein the positioning unit is configured to determine a location of the user terminal;
wherein the information server is configured to store service information containing location parameters;
wherein the information server is configured to provide, via the communication unit, service information to the user terminal that matches the location of the user terminal; and
wherein the method comprises:
communicating the user terminal with the positioning unit to obtain a initial position information of the user terminal;
determining a position of the user terminal based on a distance between the user terminal and the positioning unit; and
receiving, at the user terminal, service information provided by the information server, wherein the service information matches the position of the user terminal.

13. The method of claim 12, wherein:
the user terminal is configured to receive a positioning signal transmitted by the positioning unit and determine the distance between the user terminal and the positioning unit based on a strength of the positioning signal.

14. The method of claim 13, further comprising: if the user terminal receives the positioning signal transmitted by a positioning node in the positioning unit, then using a position of the positioning node as the initial position, and determining the position of the user terminal based on the strength of the positioning signal transmitted by the positioning node.

15. The method of claim 13, further comprising:
if the user terminal receives positioning signals from two or more positioning nodes in the positioning unit, then
determining an intersecting area between the positioning signals transmitted by the two or more positioning nodes;
using a position of at least one positioning node as the initial position; and
determining the position of the user terminal based on the strength of the positioning signals transmitted by the positioning nodes.

16. The method of claim 15, further comprising:
after the determination of the intersecting area, determining the position of the user terminal by:
using the position of any one of the two or more positioning nodes as the initial position;
assessing a distance between the user terminal and the one positioning node by assessing the strength of the positioning signal transmitted by the one positioning node.

17. The method of claim 15, further comprising:
after the determination of the intersecting area, determining the position of the user terminal by:
using positions of the at least two positioning nodes as initial positions;
respectively assessing strengths of the positioning signal transmitted by each of the at least two positioning nodes to determine a distance between the user terminal and each of at least two positioning nodes, thereby determining the location of the user terminal.

18. The method of claim 12, wherein the user terminal receives service information from the information server by:
transmitting, from the user terminal, position information of the user terminal to the information server via the communication unit of the information service system;
receiving, at the information server, the position information;
selecting, from the service information containing position parameters, service information that matches the position information;
transmitting the selected service information from the information server to the user terminal via the communication unit; and
receiving, at the user terminal, the service information transmitted by the communication unit.

19. The method of claim 12, wherein the user terminal receives service information from the information server by:
transmitting, from the information server via the communication unit of the information service system, service information containing positioning parameters to the user terminals; and
comparing, at the user terminal, the positioning parameters contained in the received service information with its own position information, and selecting the service information that matches the position information of the user terminal.

20. The method of claim 11, further comprising:
determining locations of a plurality of user terminals; and
sending location-specific real time information to the plurality of user terminals based on the determined locations of the plurality of user terminals.
